(19) United States
(12) Patent Application Publication
(10) Pub. No.: US 2002/0164041 A1
(43) Pub. Date: Nov. 7, 2002

(54) Directional receiver for hearing aids

(75) Inventor: Patrick M. Zurek, Arlington, MA (US)

Correspondence Address: HALE AND DORR, LLP, 60 STATE STREET, BOSTON, MA, 02109

(73) Assignee: Sensimetrics Corporation

(21) Appl. No.: 10/108,259

(22) Filed: Mar. 27, 2002

Related U.S. Application Data
(60) Provisional application No. 60/279,163, filed on Mar. 27, 2001.

(51) Int. Cl. H04R 25/00; H04R 9/08; H04R 11/04; H04R 17/02; H04R 19/04; H04R 21/02

(52) U.S. Cl. 381/313; 381/312; 381/356

(57) ABSTRACT

A hearing aid has a directional receiving system with a more efficient direction into the patient's ear than away from the patient's ear.

### CROSS REFERENCE TO RELATED APPLICATION

This application claims priority from Provisional Serial No. 60/279,163, filed Mar. 27, 2001, which is incorporated herein by reference.

### BACKGROUND OF THE INVENTION

Hearing aids are typically designed to fit snugly into the outer ear with a custom-molded earmold or shell. This snug fit achieves two goals. First, a device that is custom-fitted to the ear remains securely in the ear and is less prone to coming loose than one that is not custom fitted. Second, a tight fit decreases acoustic feedback, which is the cause of whistling in hearing aids. There are drawbacks, however, to such a tight fitting hearing aid. A tight fit leads to the uncomfortable feeling of a plugged ear, and leads to an undesirable “occlusion effect,” i.e., the amplification of one's own voice caused by plugging the ear. Although some hearing aids have been designed so as not to occlude the ear, such aids are limited by acoustic feedback and the amount of amplification that they can provide to the user.

### SUMMARY OF THE INVENTION

The present invention includes a hearing aid with a directional receiver system to increase the amount of amplification that can be provided to a hearing-aid user without providing whistling. Unlike current hearing aids that use receivers (i.e., miniature loudspeakers that provide the amplified acoustic signals to the user) that are omnidirectional in that they radiate sound approximately equally well in all directions, the hearing aid of the present invention uses a directional receiver that radiates more sound power in one direction than in other directions.

By arranging a directional receiver so that the most efficient direction points into the ear, increased sound power is delivered to the ear without a proportional increase in the amount of acoustic feedback. Other features and advantages become apparent from the following detailed description, drawings, and claims.

### BRIEF DESCRIPTION OF THE DRAWINGS

FIG. 1 is a side view of a behind-the-ear hearing aid showing two displaced sound tubes.

FIG. 2 is a block diagram showing processing of a signal received from a hearing aid microphone.

FIG. 3 is a diagram illustrating a normalized acoustic radiation pattern.

### DETAILED DESCRIPTION

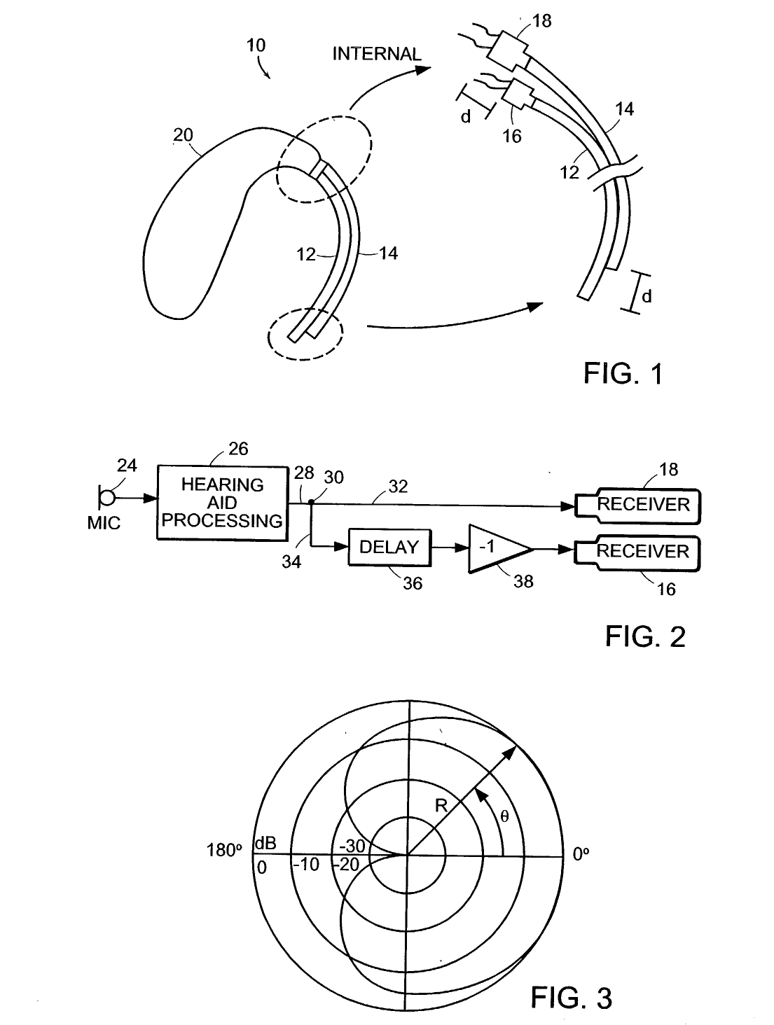

In one implementation of the present invention, as shown in FIG. 1, a behind-the-ear style hearing aid 10 has a housing 20 and two attached acoustic tubes 12, 14 extending away from housing 20 for transmitting sound to a patient's ear canal. At the end, away from the housing, acoustic tubes 12, 14 are connected to respective receivers 16, 18 that can be driven by independent electrical signals. Housing 20 houses a microphone and acoustic signal processing. Tubes 12, 14 have equal length but are displaced relative to one another so that the ends at the entrance to the ear canal and the ends at the hearing aid housing are each spaced apart by a distance d (not zero or substantially zero).

A microphone 24 (located in housing 20) provides a signal that is processed as indicated in the block diagram in FIG. 2. The microphone provides a signal to known hearing aid signal processing that includes frequency shaping, amplification, compression, and other known processing techniques, which are lumped together in a “Hearing Aid Processing” block 26. The processed signal 28 is then split into two components at a node 30. A first component 32 drives receiver 18 directly. A second component 34 is delayed in a delay block 36 and inverted by an inverter 38 before driving receiver 16.

With this arrangement of receivers, sound tubes, and signal processing, and with an internal delay equal to d/c (where c is the speed of sound), the resulting normalized acoustic radiation pattern will be similar in shape to that shown in FIG. 3. There will be an on-axis direction (0°) in which radiation will be strongest due to the reinforcement of acoustic signals, while in the direction 180° opposite there is a null due to cancellation of the acoustic signals. The arrangement that delivers maximal power into the ear has the tips of the two tubes on a line pointing into the ear with tube 12 proximal and tube 14 distal.

Due both to the termination of the tubes into the open ear canal and to the gradient nature of the processing, the signal that reaches the eardrum from this hearing aid will be strongly high-passed. This effect can be compensated to some extent by prior linear filtering (which can be included as part of the hearing aid processing in the block).

Other configurations that make use of the same principles can be envisioned. For example, it is possible to increase the degree of directionality by employing more than two receiver/sound tube combinations. In addition, frequency-dependent processing can be used to replace the wide band delay and inversion described above.

Having described an embodiment of the present invention, modifications can be made without departing from the scope of the invention as defined by the appended claims. For example, the hearing aid can be occluding or non-occluding.

What is claimed is:

1. A hearing aid with a directional receiver system for providing acoustic signals to the patient with a more efficient direction into the patient's ear than away from the patient's ear.

2. The hearing aid of claim 1, wherein the directional receiver system includes first and second receivers and first and second sound tubes, with each of the receivers for providing sound to a respective first or second sound tube.

3. The hearing aid of claim 2, wherein the first and second sound tubes have equal length but are displaced from each other a non-zero distance d.

4. The hearing aid of claim 3, further comprising a microphone, wherein the directional receiving system includes signal processing circuitry that receives a signal from the microphone and provides a processed signal to each of the first and second receivers.

5. The hearing aid of claim 4, wherein the processed signal is both provided to the first receiver, and inverted and delayed and then provided to the second receiver.

6. The hearing aid of claim 5, wherein the delay is a function of d and the speed of sound, c.

7. The hearing aid system of claim 1, further comprising a microphone, wherein the directional receiving system includes signal processing circuitry that receives a signal from the microphone and provides a processed signal to each of first and second receivers.

8. The hearing aid of claim 7, wherein the signal processing circuitry includes frequency shaping and amplification.

9. The hearing aid of claim 7, wherein the signal processing circuitry includes frequency-dependent processing.

10. A method for use with a hearing aid comprising:
receiving an acoustic signal; and
processing the acoustic signal to provide, to respective first and second receivers, first and second signals that at least partially cancel each other in one direction to create relatively more and relatively less efficient directions.

11. The method of claim 10, including providing the first and second signals to first and second sound tubes.

12. The method of claim 11, wherein the first and second sound tubes have equal length but are displaced from each other by a non-zero distance.

13. The method of claim 12, wherein the processing is performed with signal processing circuitry that receives a signal from the microphone and provides a processed signal to each of the first and second receivers.

14. The method of claim 13, wherein the processed signal is both provided to the first receiver, and inverted and delayed and then provided to the second receiver.

15. The method of claim 11, wherein the hearing aid is configured so that a more efficient direction is into a user's ear.

16. The method of claim 10, wherein the processing includes frequency-dependent processing.

17. The method of claim 10, wherein the processing includes frequency shaping and amplification.

18. The method of claim 10, wherein the first and second signals at least partially reinforce each other in at lease one direction.
